(19) United States
(12) Patent Application Publication
(10) Pub. No.: US 2002/0187896 A1
(43) Pub. Date: Dec. 12, 2002

(54) Carbon molecular sieve and process for preparing the same

(76) Inventors: Ryong Ryoo, Shinsung-dong (KR); Sang Hoon Joo, Seaul (KR); Seong Jae Choi, Seoul (KR)

Correspondence Address: KNOBBE MARTENS OLSON & BEAR LLP, 2040 MAIN STREET, FOURTEENTH FLOOR, IRVINE, CA, 91614, US

(21) Appl. No.: 10/004,350

(22) Filed: Oct. 25, 2001

(30) Foreign Application Priority Data
Apr. 30, 2001 (KR) 10-2001-0023541

(51) Int. Cl. C01B 31/02

(52) U.S. Cl. 502/418; 423/445 R; 95/116

(57) ABSTRACT

The present invention provides a carbon molecular sieve prepared by forming carbon nanorods or carbon nanotubes with a uniform diameter inside pores of siliceous mesoporous molecular sieve and a process for preparing the same. The process for preparing a carbon molecular sieve of the present invention comprises the steps of; adsorbing a mixture of an aqueous carbohydrate solution and an acid or a precursor of carbon polymer into pores of mesoporous silica molecular sieve template, and polymerizing; heating the mesoporous molecular sieve including polymeric material at 400 to 1400° C. under vacuum condition or without oxygen to accomplish thermal decomposition of the polymeric material included in the pores; and, reacting the heated mesoporous molecular sieve with hydrofluoric acid or aqueous sodium hydroxide solution and removing the template to obtain a carbon molecular sieve. The carbon molecular sieve of the invention is superior in terms of the hydrogen adsorption effect and the activity for oxygen reduction, which makes possible its universal application for the development of adsorbents for organic materials, sensors, electrodes, and materials for fuel cells and hydrogen storage.

### BACKGROUND OF THE INVENTION

1. Field of the Invention

The present invention relates to a carbon molecular sieve and a process for preparing the same, more specifically, to a carbon molecular sieve prepared by forming carbon nanorods or carbon nanotubes with a uniform diameter inside pores of siliceous mesoporous molecular sieve and a process for preparing the same.

2. Description of the Related Art

In general, molecular sieves are known as a class of materials in which pores with a uniform size form a well-ordered structure, e.g., zeolite. The molecular sieves, due to their uniform pore size, show a high selectivity on the molecules with specific molecular sizes, which makes their practical applications such as catalysts, catalyst substrates, or adsorbents. Many studies have been actively performed on the carbon molecular sieves possessing several advantages of high thermal stability, hydrothermal stability, chemical resistance, and hydrophobicity, over the conventional metal oxide molecular sieves such as zeolite. The carbon molecular sieves, though they have pores with a relatively uniform size when compared to carbon black, are proved less satisfactory in the senses that their pore sizes less than 0.5 nm and irregular arrangement of the pores have limited their applications only to the adsorption or separation of small molecules.

Recently, it has been reported that a carbon molecular sieve with a uniform pore size and structural regularity can be prepared by using mesoporous silica molecular sieve template MCM-48. Academic society has paid attention to the carbon molecular sieve with structural regularity described above as a promising carbon molecular sieve with a uniform pore size and structural regularity. The carbon molecular sieves have been prepared by using mesoporous molecular sieve MCM-48 and a newly developed catalyst carbonization process. Continued studies have revealed that several carbon molecular sieves with structural diversity can be prepared by using mesoporous molecular sieves such as SBA-1, SBA-15, KIT-1 and MSU-1 as templates, and focused on the application of these materials to catalyst supports, adsorbents for organic materials, sensors, electrode materials, and materials for hydrogen storage. Especially, it is expected to have tremendous effect on the hydrogen battery and related areas if hydrogen can be stored with a high efficiency. However, the carbon molecular sieve that can efficiently store hydrogen has not been yet reported in the art.

Therefore, there are strong reasons for developing and exploring a novel carbon molecular sieve that can store hydrogen in an efficient manner.

### SUMMARY OF THE INVENTION

The present inventors have made an effort to develop a carbon molecular sieve that can efficiently store hydrogen, observed that if the pores of the carbon molecular sieve are of one-dimensional structure or have a bundle structure of carbon nanotubes connected to one another, the materials can be applied for hydrogen storage, and discovered that a carbon molecular sieve in which carbon nanorods or carbon nanotubes with a uniform size are hexagonally arranged, can be prepared by using mesoporous molecular sieve with one-dimensional pore structure as a template and then forming carbon nanorods or carbon nanotubes with a uniform diameter inside pores of the siliceous mesoporous molecular sieve.

An aspect of the present invention provides a process for preparing a carbon molecular sieve. The process comprises: providing a template having an internal structure defining pores; contacting a composition with the template so as for the template to absorb and retain the composition in the pores thereof, wherein the composition comprises a polymerizable compound comprising carbons; polymerizing the polymerizable compound while being retained in the pores of the template, thereby forming a polymeric material having carbons retained in the pores of the template; subjecting the template and the polymeric material retained therein to heating sufficient to thermally decompose the polymeric material and to substantially remove non-carbon elements therefrom; and removing the template.

In the process, the removal of the template comprises contacting the template with an acid or base. The acid comprises hydrofluoric acid, and the base comprises a sodium hydroxide. The acid or base for removal of the template is in an aqueous or alcoholic solution. The template comprises a molecular sieve. The template comprises a mesoporous silica molecular sieve. The mesoporous silica molecular sieve comprises aluminum. The pores of the template comprises one-dimensional pores interconnected one another. The size of the one-dimensional pores is from about 1 nm to about 50 nm. The size of the one-dimensional pores is from about 2 nm to about 20 nm. The template comprises SBA-15, Aluminum SBA-15, SBA-3 or Aluminum SBA-3. The polymerizable compound comprises a carbohydrate. The carbohydrate is selected from the group consisting of sucrose, xylose and glucose. The composition further comprises an acid. The acid is selected from the group consisting of sulfuric acid, hydrochloric acid, nitric acid, sulfonic acid and methylsulfonic acid. The polymerizable compound comprises a non-carbohydrate precursor of a polymer. The non-carbohydrate precursor is selected from the group consisting of furfuryl alcohol, aniline, acetylene and propylene. The heating for the thermal decomposition of the polymeric material is performed under vacuum or without oxygen. The heating is to heat the polymeric material at a temperature of from about 400° C. to about 1400° C.

Another aspect of the present invention provides a carbon molecular sieve produced by the above-described process.

A further aspect of the present invention provides a carbon molecular sieve comprising an internal structure of carbon atoms, which defines at least partly substantially uniform pores, wherein the pores have a diameter of from about 1 nm to about 50 nm. The pore size is from about 2 nm to about 20 nm. The volume of the pores is from about 1.0 cm³/g to about 3.0 cm³/g. A Brunauer-Emmett-Teller (BET) specific surface area is from about 1000 m³/g to about 3000 m³/g. The carbon atoms form nano-lines which form a substantially uniform hexagonal structure, and wherein the pores have substantially a single uniform diameter. The carbon atoms form nano-tubes which form a substantially uniform hexagonal structure, and wherein the pores have substantially two uniform diameters.

A still further aspect of the present invention provides a method of storing hydrogen. The method comprises providing a composition comprising the above-described carbon molecular sieve; and contacting hydrogen with the composition so that the carbon molecular sieve in the composition can absorb and retain the hydrogen in the internal structure thereof.

### BRIEF DESCRIPTION OF THE DRAWINGS

The above and the other objects and features of the present invention will become apparent from the following descriptions given in conjunction with the accompanying drawings.

FIG. 1 shows a transmission electron micrograph of CMK-3 structure.

FIG. 2 shows X-ray diffraction (“XRD”) patterns of SBA-15 and CMK-3.

FIG. 3 shows a graph showing nitrogen adsorption isotherm of CMK-3, and the inserted picture shows pore size distribution of CMK-3 obtained by Kruk-Jaroniec-Sayari method from the nitrogen adsorption isotherm.

FIG. 4 shows XRD patterns of CMK-3 prepared by using various mixed solutions.

FIG. 5a shows XRD patterns of hexagonal mesoporous silica molecular sieves depending on the mixed ratios of surfactants.

FIG. 5b shows XRD patterns of CMK-3 prepared by using the hexagonal mesoporous silica molecular sieve as a template.

FIG. 6 shows an XRD pattern of CMK-3 prepared by using acetylene.

FIG. 7 shows an electron micrograph of CMK-5 structure.

FIG. 8 shows XRD patterns of SBA-15 and CMK-5.

FIG. 9 shows a graph showing nitrogen adsorption isotherm of CMK-5, and the inserted picture shows pore size distribution of CMK-5 obtained by Kruk-Jaroniec-Sayari method from the nitrogen adsorption isotherm.

FIG. 10 shows XRD patterns of CMK-5 prepared by using the variable amount of furfuryl alcohol.

FIG. 11 shows a graph showing the activity change of platinum catalyst for oxygen reduction depending on the content of platinum supported on CMK-5 and carbon black.

### DETAILED DESCRIPTION OF THE PREFERRED EMBODIMENT

The process for preparing a carbon molecular sieve of the present invention comprises the steps of; adsorbing a mixture of an aqueous carbohydrate solution and an acid or a precursor of a carbon polymer into pores of mesoporous silica molecular sieve template, and then drying and polymerizing; heating the mesoporous molecular sieve including polymeric material at 400 to 1400° C. under vacuum condition or without oxygen to accomplish thermal decomposition of the polymeric material included in the pores; and, reacting the heated mesoporous molecular sieve with hydrofluoric acid or aqueous sodium hydroxide solution and removing the template to obtain a carbon molecular sieve.

The process for preparing a carbon molecular sieve is illustrated in more detail.

### Step 1

### Polymerization of Starting Material

A mixture of an aqueous carbohydrate solution and an acid or a precursor of carbon polymer (carbon source of carbon polymer) is adsorbed into pores of mesoporous silica molecular sieve template and polymerized at the temperature of 60 to 100° C.: Molecular sieves with one-dimensional pores ranging 1 to 50 nm, preferably 2 to 20 nm which are inter-connected by micropores, preferably SBA-15 or SBA-3, may be used as the mesoporous silica molecular sieve template. Water-soluble monosaccharides, disaccharides or polysaccharides may be preferably used as the carbohydrates, more preferably, sucrose, xylose, or glucose. The acid includes sulfuric acid, hydrochloric acid, nitric acid, sulfonic acid, and methylsulfonic acid that can condense or polymerize the precursors of carbohydrates or polymers, and furfuryl alcohol, aniline, acetylene, or propylene is preferred for the precursor of carbon polymer. The above procedure may be repeated several times depending on the type and the amount of carbon compounds.

### Step 2

### Thermal Decomposition

The mesoporous molecular sieve including the polymeric materials obtained above is heated at 400 to 1400° C. under vacuum condition or without oxygen to accomplish thermal decomposition of the polymeric materials included in the pores, by which the polymerized carbon compounds in the pores are thermally decomposed, and most of the components except carbon become disappeared.

### Step 3

### Removal of Template

The heated mesoporous molecular sieve is reacted with hydrofluoric acid or aqueous sodium hydroxide solution, and then the template is removed to obtain a carbon molecular sieve: This step may be repeated several times depending on the type and the amount of carbon compounds, or the reaction can be performed with the addition of ethanol to hydrofluoric acid or aqueous sodium hydroxide solution.

The carbon molecular sieve prepared by the above- described process is a material in which carbon nanorods or carbon nanotubes with a uniform diameter have the hexagonal arrangement. A rod-type carbon molecular sieve prepared by using SBA-15 or a mesoporous silica molecular sieve with similar hexagonal structure as a template and sucrose, acetylene, or furfuryl alcohol under acid catalysis is named as “CMK-3” and a tube-type carbon molecular sieve prepared by using an aluminum grafted mesoporous molecular sieve as a template and condensing furfuryl alcohol is named as “CMK-5”.

CMK-3 and CMK-5 can be used as the supports for the materials with catalytic activity, which makes possible their application in adsorbents for organic materials, sensors, electrodes, and materials for fuel cells and hydrogen storage. Actually, in the course of the reduction of oxygen that occurs at the cathode of a cell, the CMK-5 material supported with platinum showed more than 10 times higher activity compared to a fuel cell electrode material of Vulcan XC-72 carbon. In addition, it was also observed that CMK-5 supported with platinum underwent the violent oxidation with flames when methanol or ethanol was added to the material, indicating that the platinum catalyst prepared by supporting platinum on CMK-5 would show a high activity when applied to methanol and ethanol fuel cells.

The present invention is further illustrated by the following examples, which should not be taken to limit the scope of the invention.

### EXAMPLE 1

### Preparation of CMK-3

After preheating a mixture of 0.5 g EO₂₀PO₇₀EO₂₀ (Pluronic P123, BASF) and 10 mL of 1.6M aqueous hydrochloric acid solution at a temperature of 35° C., 1.1 g tetraethylorthosilicate (TEOS, 98%, Acros) was added to the mixture, and stirred for 6 min. The reaction mixture was then reacted for 24 h at 35° C., and 12 h at 100,° C. respectively. The precipitate was filtered and dried at 100° C. to yield mesoporous molecular sieve SBA-15 (see: Zhao et al., Science, 279:548, 1998).

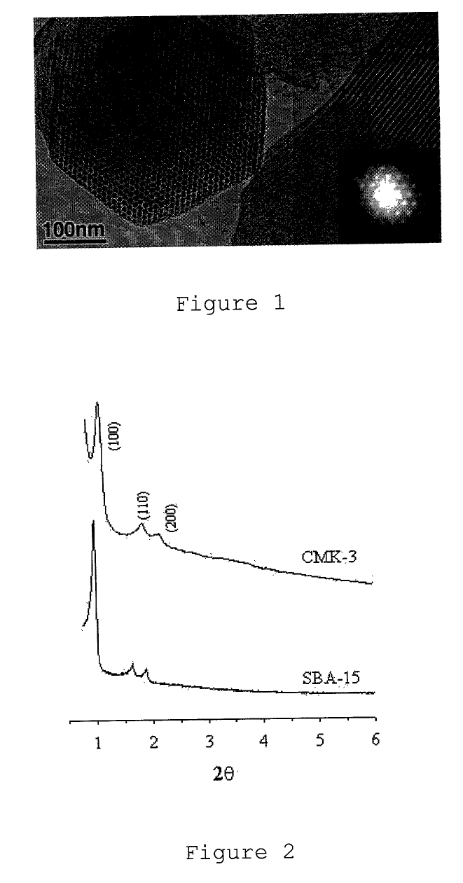

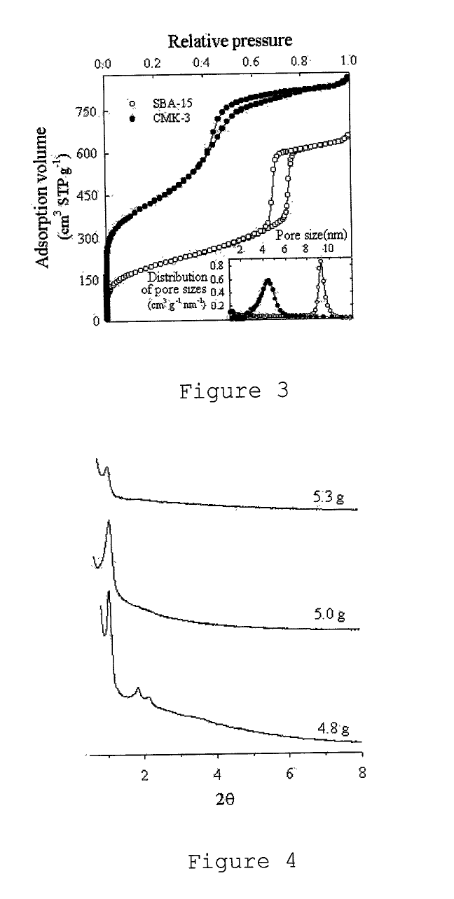

SBA-15 was added to a mixture of 5.3 g of 20% (w/w) aqueous sucrose solution and 0.08 mL sulfuric acid, and then the reaction mixture was slowly heated to 140° C. to dry and polymerize the reaction mixture. The unreacted sulfuric acid and water adsorbed in the pores were removed by heating at 200° C. under vacuum, followed by thermal decomposition. Then, SBA-15 template was removed with 10% (w/w) aqueous hydrofluoric acid to give a carbon molecular sieve CMK-3 (see: FIGS. 1 and 2). FIGS. 1 and 2 show a transmission electron micrograph of CMK-3, and XRD patterns of SBA-15 and CMK-3, respectively. As shown in FIG. 1, carbon nanolines are well connected in the uniform hexagonal structure, and CMK-3 perfectly maintains the structure of SBA-15 used as a template. FIG. 2 also shows that CMK-3 perfectly maintains the structure of SBA-15 because the diffraction peaks corresponding to the hexagonal structure appear in identical patterns as shown in XRD patterns of SBA-15 and CMK-3 prepared by using SBA-15 as a template. Nitrogen adsorption-desorption experiment was performed to examine the pore distribution of the prepared CMK-3 (see: FIG. 3). FIG. 3 shows a graph showing nitrogen adsorption isotherm of CMK-3, and the inserted picture shows pore size distribution of CMK-3 obtained by Kruk-Jaroniec-Sayari method from the nitrogen adsorption isotherm. As shown in FIG. 3, CMK-3 was observed to have characteristic features of mesoporous molecular sieve that has uniform mesopores with a diameter of 4.0 nm, a BET (Brunauer-Emmett-Teller) adsorption area of 1,520 m²/g, and a pore volume of 1.3 cm³/g.

### EXAMPLE 2

### Preparation of CMK-3 With Varied Amount of Sucrose

Three kinds of CMK-3 were prepared in a similar fashion as above, except that a mixed solution of 4.8 g of 15.8% (w/w) aqueous sucrose solution and 0.04 mL sulfuric acid, a mixed solution of 5.0 g of 20% (w/w) aqueous sucrose solution and 0.06 mL sulfuric acid, or a mixed solution of 5.3 g of 20% (w/w) aqueous sucrose solution and 0.04 mL sulfuric acid was retreated before thermal decomposition, and then their XRD patterns were analyzed, respectively (see: FIG. 4). FIG. 4 shows XRD patterns of CMK-3 prepared by using various mixed solutions, where the numbers represent the amount of sucrose contained in each solution. As shown in FIG. 4, the XRD patterns were changed depending on the amount of sucrose.

### EXAMPLE 3

### Preparation of CMK-3 Using Hexagonal Mesoporous Silica Materials Prepared by Using Surfactant Mixture

A mixture of 14.29 g Ludox HS40 (colloid silica, DuPont, U.S.A.) and 100 g of 1M aqueous sodium hydroxide solution prepared at 80° C. for 2 h was added to the preheated mixture of a surfactant mixture of hexadecyltrimethylammonium bromide (HTABr, Acros, 99%), C₁₆H₃₃(OC₂H₅)₂ (Brij 52, Aldrich), and C₁₆H₃₃(OC₂H₅)₁₀ (Brij 56, Aldrich) and hydrochloric acid at 35° C., and then the resulting mixture was stirred for 5 min. After the resultant was further reacted for 12 h at 35° C., and 12 h at 100° C., the precipitate was filtered and dried at 100° C. to yield hexagonal mesoporous silica molecular sieve (see: Kim and Stucky, Chem. Commun., p1159, 2000), where the ratio of the mixed surfactant, HTABr:C₁₆H₃₃ (OC₂H₅)₂:C₁₆H₃₃ (OC₂H₅)₁₀ was 0:0.14:0.86, 0.33:0.09:0.57, 0.66:0.05:0.29, or 1:0:0 (w/w/w), respectively.

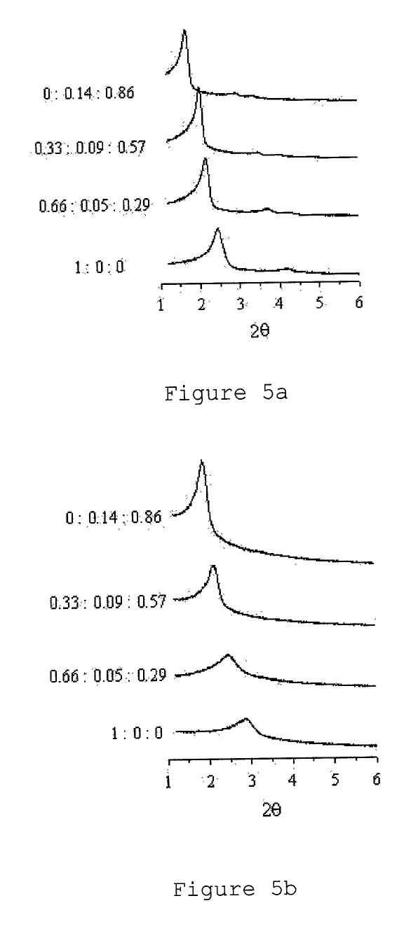

After the addition of 1 g of each hexagonal mesoporous silica molecular sieve prepared above to a mixture of 5.3 g of 20% (w/w) aqueous sucrose solution and 0.08 mL sulfuric acid, the mixture was slowly heated to 140° C. to dry and polymerize the reaction mixture. The unreacted sulfuric acid and water adsorbed in the pores were removed by heating at 200° C. under vacuum, followed by thermal decomposition at 900° C. under vacuum. Then, the hexagonal mesoporous silica molecular sieve was removed with 10% (w/w) aqueous hydrofluoric acid to yield CMK-3, and XRD analysis was performed for the hexagonal mesoporous silica molecular sieve and CMK-3 (see: FIGS. 5a and 5b). FIG. 5a shows XRD patterns of hexagonal mesoporous silica molecular sieves depending on the mixed ratios of surfactants and FIG. 5b shows XRD patterns of CMK-3 prepared by using the hexagonal mesoporous silica molecular sieve described above as a template. The numbers shown in the figures represent the mixed ratios of the surfactants. As shown in FIGS. 5a and 5b, the pore sizes of CMK-3 were varied while maintaining the identical structure of the hexagonal mesoporous silica molecular sieve when the mixed ratios of the surfactants were changed.

### EXAMPLE 4

### Preparation of CMK-3 Using Acetylene

SBA-15 prepared in Example 1 was added to a solution of anhydrous aluminum chloride (AlCl₃) in anhydrous ethanol, and then stirred for 1 h at room temperature. The precipitate was filtered, washed with anhydrous ethanol, and then dried at 140° C. Calcination of the dried precipitate was made for 5 h at 550° C. under air stream to give AlSBA-15 in which aluminum is grafted onto SBA-15 ( see: Ryoo et al., Chem. Commun., p2225, 1997).

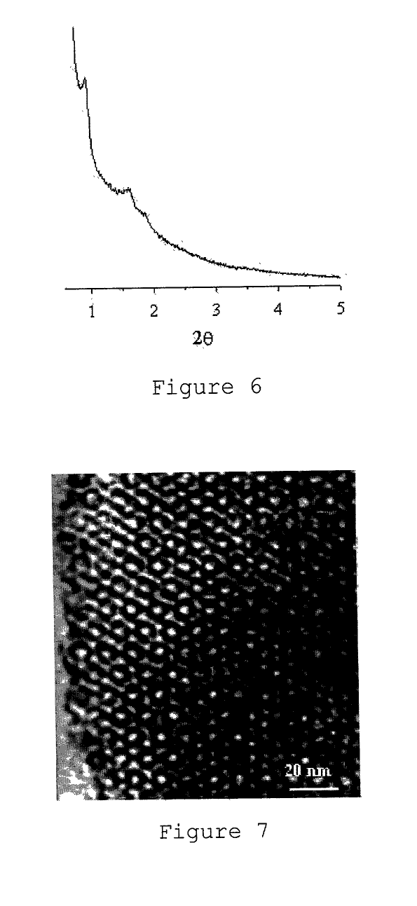

CMK-3 was prepared in an analogous manner as in Example 1 except that 1 g AlSBA-15 obtained above was subjected to a vacuum condition at 400° C. and adsorbed under the flow of acetylene gas for 30 min at 800° C. (see: FIG. 6). FIG. 6 shows an XRD pattern of CMK-3 prepared by using acetylene, which shows similar XRD pattern to those of CMK-3 prepared in Examples 1 to 3 with minor differences.

### EXAMPLE 5

### Preparation of CMK-5

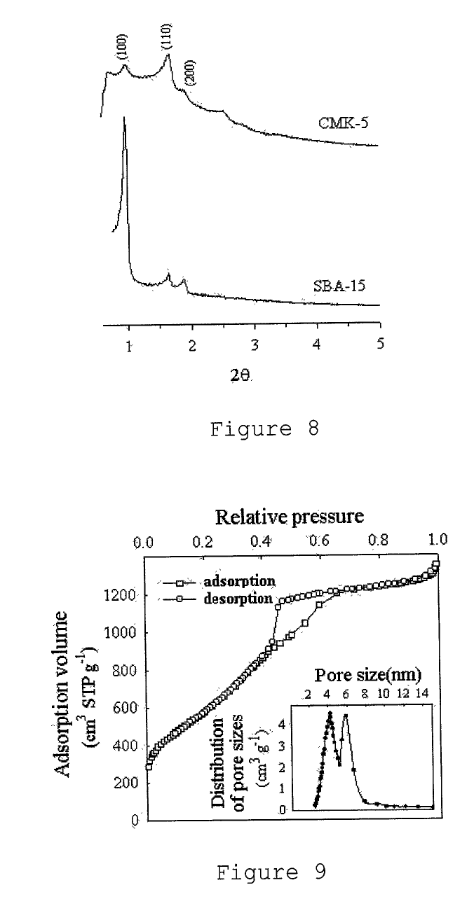

After AlSBA-15 prepared in Example 4 was subjected to a vacuum condition, 1 g of furfuryl alcohol per 1 g of AlSBA-15 was added under nitrogen, and the resulting mixture was heated for 3 h at 35° C. under reduced pressure to promote the uniform adsorption of furfuryl alcohol. CMK-5 was prepared by the polymerization at 95° C. for 12 h followed by the thermal decomposition by heating at 900° C. under vacuum, and then removal of AlSBA-15 template with 10% (w/w) aqueous hydrofluoric acid solution. The pore size distribution of CMK-5 was measured by the same method described in Example 1 (see: FIGS. 7, 8, and 9). FIG. 7 shows an electron micrograph of CMK-5 structure, demonstrating that in the case of CMK-5, unlike CMK-3, pores of SBA-15 was not filled with carbon nanorods, rather, formed with nanotubes. It is assumed that furfuryl alcohol was condensed from the surface by the action of aluminum grafted on the surface of SBA-15 frame that functions as an acid site. FIG. 8 shows XRD patterns of SBA-15 and CMK-5, and shows the characteristic feature that the intensity of peak (100) of CMK-5 is extremely small. FIG. 9 shows a graph showing nitrogen adsorption isotherm of CMK-5, and the inserted picture shows pore size distribution of CMK-5 obtained by Kruk-Jaroniec-Sayari method from the nitrogen adsorption isotherm. As shown in FIG. 9, CMK-5 presents the characters of mesoporous molecular sieves in a sense that it has two types of mesopores with diameters of 4.2 nm and 6.0 nm, a BET adsorption area of 2,050 m²/g, and a pore volume of 2.1 cm³/g, demonstrating that CMK-5 is a carbon molecular sieve containing two types of mesopores with different sizes.

### EXAMPLE 6

### Preparation of CMK-5 Using Varied Amount of Furfury Alcohol

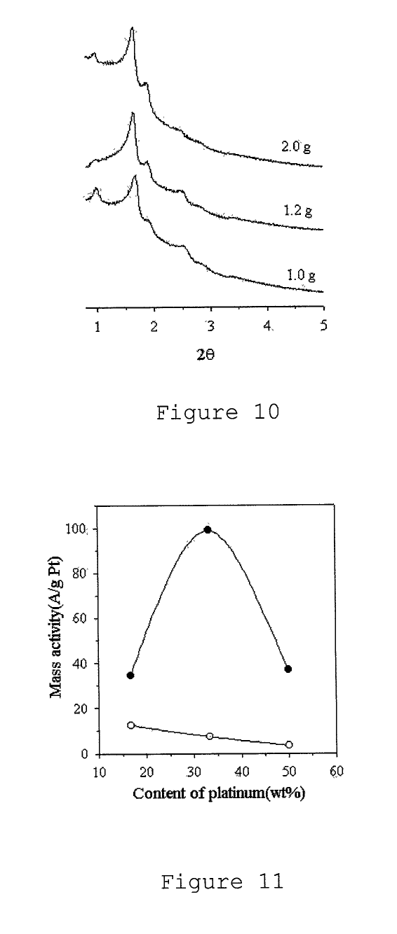

CMK-5 was prepared similarly as in Example 5, except that the furfuryl alcohol is added in an amount of 1.0 g, 1.2 g, or 2.0 g (see: FIG. 10). FIG. 10 shows XRD patterns of CMK-5 prepared by using varied amount of furfuryl alcohol, where the numbers represent the amount of added furfuryl alcohol. As shown in FIG. 10, it was clearly demonstrated that the basic structure of CMK-5 is not changed by the addition amount of furfuryl alcohol, while the diameter of CMK-5 is changed.

### EXAMPLE 7

### Hydrogen Adsorption Effect of CMK-5

To evaluate the hydrogen adsorption ability of CMK-5, carbon black (Vulcan XC-72) and CMK-5 prepared in Example 5 were impregnated with a solution prepared by dissolving dichlorodihydroplatinum hexahydrate (H₂PtCl₂·6H₂O) in acetone, and then acetone was removed by thorough drying at 60° C. After the reduction to platinum under hydrogen flow at 300° C. for 2 h followed by the removal of the adsorbed hydrogen by the treatment under vacuum at 300° C. for 1 h, each platinum catalyst impregnated with the platinum content of 50% (w/w) was prepared. And then, the number of hydrogen atom adsorbed in the platinum catalyst was measured (see: Table 1).

TABLE 1
Hydrogen adsorption of each platinum cluster

| Sample | Number of adsorbed hydrogen per platinum |
|---|---|
| CMK-5 | 0.5 |
| Carbon black | 0.2 |

As shown in Table 1 above, in the case of CMK-5, more than 0.5 hydrogen atoms can be adsorbed per platinum atom. The platinum cluster is distributed on CMK-5 about 2.5 times better than on carbon black (Vulcan XC-72), when compared to the hydrogen adsorption result for the platinum cluster prepared by plating the same amount of platinum on carbon black (Vulcan XC-72) that is practically used as an electrode for fuel cells.

### EXAMPLE 8

### Measurement of Activity of Platinum Catalyst for Reduction

A mixture of nafion and each platinum catalyst (Pt/CMK-5) was prepared in a similar manner as in Example 7, except that the amount of plated platinum on CMK-5 or active carbon black (Vulcan XC-72) was 16.7%, 33,3%, or 50% (w/w), and sonicated in an aqueous solution to give the liquid drops, which was added in a dropwise to a rotational disc electrode made of hyaline carbon. The uniform film coating of the electrode by drying at 70° C. gave each rotational disc electrode. The rotational disc electrode was rotated at 10,000 rpm under HClO₄ electrolyte filled with oxygen at room temperature, and current was measured at 900 mV to measure the activity of the platinum catalyst for reduction reaction (see: FIG. 11, Table 2). FIG. 11 shows a graph showing the activity change of platinum catalyst for oxygen reduction depending on the content of platinum supported on CMK-5 and carbon black, where “∘” represents carbon black (Vulcan XC-72) and “●” represents CMK-5, respectively. As shown in FIG. 11, the activity of CMK-5, though it is variable depending on the supported amount, was superior to that of carbon black (Vulvan XC-72) (see: Table 2).

TABLE 2
Relative activity of platinum catalyst

| Content of platinum | |
|---|---|
| (%, w/w) | Relative activity of CMK-5 to Vulcan XC-72 |
| 16.7 | 2.7 |
| 33.3 | 13.7 |
| 50 | 10.8 |

As shown in Table 2 above, it was clearly demonstrated that the platinum catalyst employing CMK-5 of the invention is superior to platinum catalyst employing conventional carbon black (Vulcan XC-72). Therefore, it is expected that the platinum catalyst prepared by supporting platinum on CMK-5 will show a high activity when applied to methanol and ethanol fuel cells.

As clearly described and demonstrated above, the present invention provides a carbon molecular sieve prepared by forming carbon nanorods or carbon nanotubes with a uniform diameter inside pores of siliceous mesoporous molecular sieve and a process for preparing the same. The carbon molecular sieve of the invention is prepared by adsorbing a mixture of an aqueous carbohydrate solution and an acid or a precursor of a carbon polymer into pores of mesoporous silica molecular sieve template, polymerizing, and heat treatment. The carbon molecular sieve of the invention is superior in terms of the hydrogen adsorption effect and the activity for oxygen reduction, which makes possible its universal application for the development of adsorbents for organic materials, sensors, electrodes, and materials for fuel cells and hydrogen storage.

What is claimed is:

1. A process for preparing a carbon molecular sieve, comprising:
providing a template having an internal structure defining pores;
contacting a composition with the template so as for the template to absorb and retain the composition in the pores thereof, wherein the composition comprises a polymerizable compound comprising carbons;
polymerizing the polymerizable compound while being retained in the pores of the template, thereby forming a polymeric material having carbons retained in the pores of the template;
subjecting the template and the polymeric material retained therein to heating sufficient to thermally decompose the polymeric material and to substantially remove non-carbon elements therefrom; and
removing the template.

2. The process of claim 1, wherein the removal of the template comprises contacting the template with an acid or base.

3. The process of claim 2, wherein the acid comprises hydrofluoric acid, and the base comprises a sodium hydroxide.

4. The process of claim 2, wherein the acid or base for removal of the template is in an aqueous or alcoholic solution.

5. The process of claim 1, wherein the template comprises a molecular sieve.

6. The process of claim 1, wherein the template comprises a mesoporous silica molecular sieve.

7. The process of claim 1, wherein the mesoporous silica molecular sieve comprises aluminum.

8. The process of claim 1, wherein the pores of the template comprises one-dimensional pores interconnected one another.

9. The process of claim 8, wherein the size of the one-dimensional pores is from about 1 nm to about 50 nm.

10. The process of claim 8, wherein the size of the one-dimensional pores is from about 2 nm to about 20 mm.

11. The process of claim 1, wherein the template comprises SBA-15, Aluminum SBA-15, SBA-3 or Aluminum SBA-3.

12. The process of claim 1, wherein the polymerizable compound comprises a carbohydrate.

13. The process of claim 12, wherein the carbohydrate is selected from the group consisting of sucrose, xylose and glucose.

14. The process of claim 12, wherein the composition further comprises an acid.

15. The process of claim 14, wherein the acid is selected from the group consisting of sulfuric acid, hydrochloric acid, nitric acid, sulfonic acid and methylsulfonic acid.

16. The process of claim 1, wherein the polymerizable compound comprises a non-carbohydrate precursor of a polymer.

17. The process of claim 16, wherein the non-carbohydrate precursor is selected from the group consisting of furfuryl alcohol, aniline, acetylene and propylene.

18. The process of claim 1, wherein the heating for the thermal decomposition of the polymeric material is performed under vacuum or without oxygen.

19. The process of claim 1, wherein the heating is to heat the polymeric material at a temperature of from about 400° C. to about 1400° C.

20. A carbon molecular sieve produced by the process of claim 1.

21. A carbon molecular sieve comprising an internal structure of carbon atoms, which defines at least partly substantially uniform pores, wherein the pores have a diameter of from about 1 nm to about 50 nm.

22. The carbon molecular sieve of claim 21, wherein the pore size is from about 2 nm to about 20 nm.

23. The carbon molecular sieve material of claim 21, wherein the volume of the pores is from about 1.0 cm³/g to about 3.0 cm³/g.

24. The carbon molecular sieve of claim 21, wherein a Brunauer-Emmett-Teller (BET) specific surface area is from about 1000 m³/g to about 3000 m³/g.

25. The carbon molecular sieve of claim 21, where the carbon atoms form nano-lines which form a substantially uniform hexagonal structure, and wherein the pores have substantially a single uniform diameter.

26. The carbon molecular sieve of claim 21, where the carbon atoms form nano-tubes which form a substantially uniform hexagonal structure, and wherein the pores have substantially two uniform diameters.

27. A method of storing hydrogen, comprising:
providing a composition comprising the carbon molecular sieve of claim 21; and
contacting hydrogen with the composition so that the carbon molecular sieve in the composition can absorb and retain the hydrogen in the internal structure thereof.
